(19) United States
(12) Patent Application Publication
(10) Pub. No.: US 2005/0224306 A1
(43) Pub. Date: Oct. 13, 2005

(54) Latch assembly for vehicle power supply

(76) Inventor: James M. Kosco, West Wyoming, PA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 11/080,273

(22) Filed: Mar. 15, 2005

Related U.S. Application Data
(60) Provisional application No. 60/553,588, filed on Mar. 15, 2004.

(51) Int. Cl. B60L 9/00

(52) U.S. Cl. 191/1 R

(57) ABSTRACT

A latch assembly is provided for securing a power supply assembly to a motorized vehicle that facilitates attachment and detachment of the power supply assembly. The latch assembly includes a securing member for releasably coupling the latch assembly to a fixed member on the vehicle. A joining member rotates the securing member in order to engage and release the fixed member. A handle assembly is coupled to the joining member for activation of the latch assembly.

### RELATED APPLICATIONS

The present application claims the benefit of the filing date of provisional application No. 60/553,588, filed Mar. 15, 2004, which is herein incorporated by reference.

### FIELD OF THE INVENTION

The present invention relates to the field of latch mechanisms, and more specifically to a latch mechanism for use in securing/releasing a power supply assembly used on a motorized vehicles.

### BACKGROUND OF THE INVENTION

In recent history, the use of personalized motorized vehicles has become increasingly more popular. Such vehicles are designed to allow for individuals with limited mobility to be able to move around more freely. Examples of such vehicles include powered wheelchairs, scooters, carts, etc. Several factors have contributed to the increase in use of this type vehicle. The Americans with Disabilities Act mandated significant changes in order to provide equal access and freedom of movement/mobility to disabled individuals. This resulted in various structural changes to the construction of homes, sidewalks, public areas and places of business. Ramped surfaces are now commonplace to allow wheelchair access where previously not possible. Additionally, people today are living longer and more active lives. This has resulted in an increased elderly population who often require mobility assistance.

Additionally, recent technological advances have made personalized vehicles more attractive to many consumers. For example, the development of lower cost, long-life rechargeable power supply units (e.g., lithium batteries, fuel cells, etc.) have made vehicles more affordable to the consumer and more practical for extended everyday use. Furthermore, because the vehicles do not utilize combustion motors, they are more environmentally friendly than gas powered vehicles.

Despite the technological advances in the area of long life, rechargeable batteries that can be used to provide the power necessary for extended use of personal vehicles, there still remain some limitations. The power supply assembly contribute greatly to the weight of the vehicle, as the individual batteries can weigh in excess of twenty pounds. Furthermore, it is common for a vehicle to contain more than one battery to increase the amount of use available between charges. As a result, the power supply can contribute greatly to the difficulties that often occur in lifting and maneuvering the vehicle into other vehicles for transporting to remote destinations.

Power supply assemblies have been developed that can be removed from the vehicle to facilitate transport. Additionally, removable power supplies allow for recharging without the need for bringing the entire vehicle into close proximity with a power source. For example, the power supply assembly can be removed from a vehicle, that continues to reside in the trunk of a car, and brought into a house where it can be plugged into an electrical outlet for recharging. Detachable power supply units have been the subject of recent developments. One such design is the subject of commonly assigned U.S. application Ser. No. 10/960,800 filed Oct. 8, 2003 entitled “Power Supply Assembly for Motorized Vehicles,” which is hereby incorporated by reference in its entirety.

### SUMMARY OF THE INVENTION

A latch assembly is provided for securing a power supply assembly to a motorized vehicle. The latch assembly includes a securing member for releasably coupling the latch assembly to a fixed mounting member on the vehicle, a joining member for rotating the securing member in order to engage and release the fixed member, and a handle coupled to the joining member. Additionally, the latch assembly may include a connecting member for connecting the joining member to the handle. The handle assembly is preferably easily accessed by a user. When the user applies a force to the handle, it engages the connecting member, which in turn causes the joining member to rotate the securing member about its mounting point and release from the fixed member on the vehicle, thus allowing the power supply to be quickly and easily released.

The latch assembly may further include a resilient member to urge the securing member to reside in the position required to lock the securing member to the fixed member when no force is being exerted upon the securing member by the joining member. This allows for the latch to cause the power supply to remain locked to the vehicle when no force is being exerted upon the handle portion. Additionally, the handle assembly may include at least one handle resilient member to urge the handle portion into a desired resting position against the surface of the power supply assembly or, alternatively, within a recess formed on the assembly.

### BRIEF DESCRIPTION OF THE DRAWINGS

For the purpose of illustrating the invention, there is shown in the drawings a form which is presently preferred; it being understood, that this invention is not limited to the precise arrangements and instrumentalities shown.

FIG. 1 is a side view of a vehicle containing a detachable power supply assembly upon which the present invention is employed.

FIG. 2 is a cross-sectional view of the latch assembly of FIG. 1 in the down or mated position, as view through a cut line through one of the connecting members.

FIG. 3 is a cross-sectional view of the latch assembly of FIG. 1 in the down or mated position, as view through a cut line through one of the connecting members.

FIG. 4 is a perspective view of the latch assembly of FIG. 1.

FIG. 5 is a perspective view of the rear section of the power supply assembly of the present invention.

FIG. 6 is an exploded view of the batteries and enclosure portions of the power supply assembly of the present invention.

FIG. 7 is a perspective rear view of the latch assembly of FIG. 1.

FIG. 8 is a perspective view of the top portion of the power supply assembly.

FIG. 9 is a perspective view of the latch assembly of FIG. 1 in the down or mated position.

FIG. 10 is a perspective view of the latch assembly of FIG. 1 in the up or un-mated position.

### DETAILED DESCRIPTION OF THE DRAWINGS

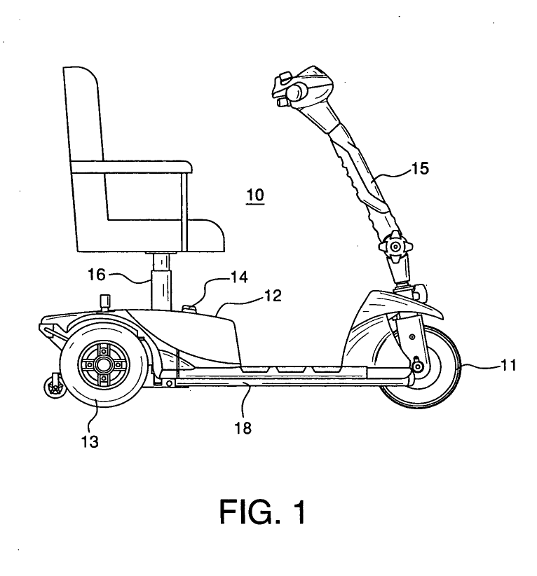

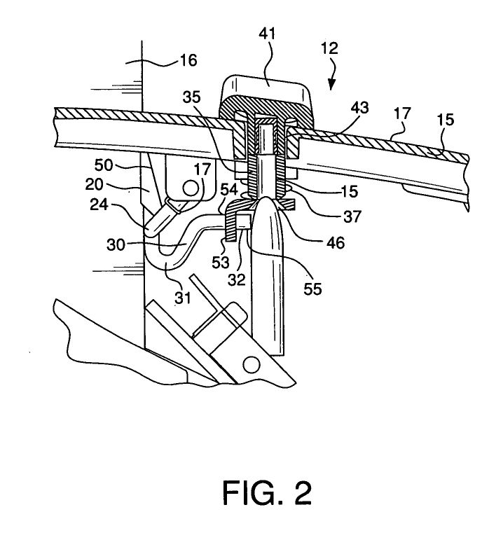

Referring to the drawings, wherein like reference numerals identify like elements, components, subassemblies, etc., FIG. 1 illustrates a personalized motorized vehicle 10 on which the invention can be employed. In the illustrated embodiment, the vehicle 10 is a three-wheeled scooter-type vehicle designed for a single passenger; however, it is understood that the invention can be practiced on any type of vehicle with a removable power supply. The vehicle 10 as illustrated includes a main frame 18, a seat post or support 16 for mounting the passenger seat, a front wheel 11 disposed in combination with a steering column 15 and rear wheels 13. The vehicle 10 also includes a detachable power supply assembly 12. A latch assembly 14 in accordance with the present invention secures the power supply 12 to the vehicle 10. The detailed components of the latch assembly 14 will be further described below with reference to additional FIGS. 2-8.

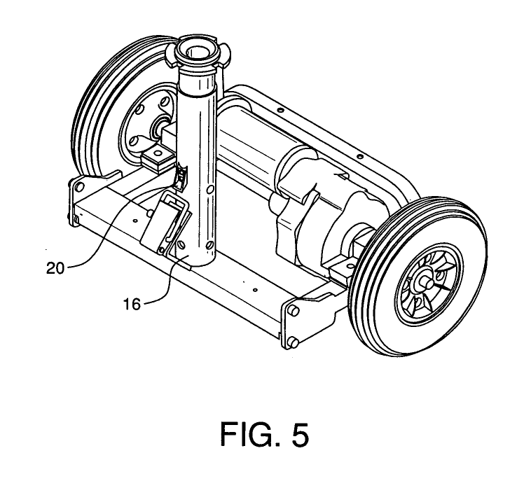

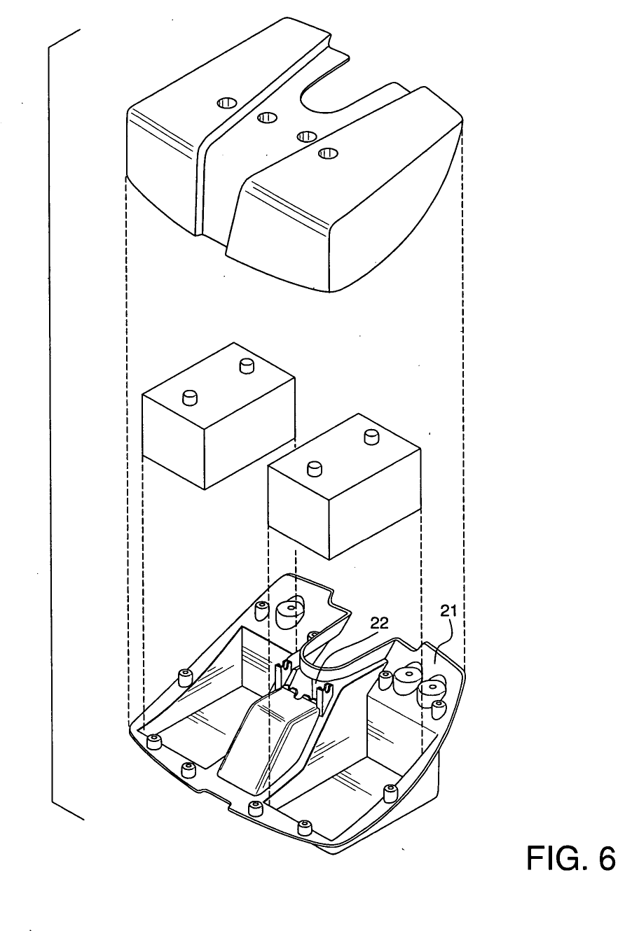

Referring to FIGS. 2-4, the detailed components of the latch assembly 14 are illustrated. FIG. 2 shows the vehicle 10 with the power supply assembly 12 installed and residing in the operative position. The assembly 12 is positioned adjacent to seat support post 16. A fixed member 20 is formed on the post. The fixed member 20 allows for a locking point to which the portion of the latch assembly 14 can mate. Referring to FIG. 5, the vehicle 10 is shown with the assembly 12 removed to allow for a clear illustration of the fixed member 20. The fixed member 20 is preferably formed of a high strength material, such as metal, and is securely coupled to the seat post 16 using fasteners, such as screws or rivets. Alternatively, the fixed member 20 can be formed directly as part of the seat support 16 during the manufacturing stage. Referring again to FIG. 2, the fixed member 20 is positioned on the seat support 16 such that it will reside below the top surface of the assembly 12, after it is placed on the vehicle 10. This allows for the fixed member 20 to extend into the power supply assembly 12 via an opening 22 in the bottom portion 21 (see FIG. 6).

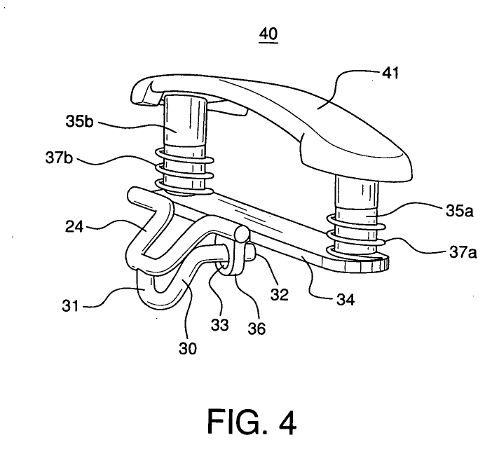

A securing member 24 resides within the assembly 12. The securing member 24 is used for locking the power supply to the fixed member 20. The securing member 24 comprises a U-shaped structure, as particularly shown in FIG. 4.

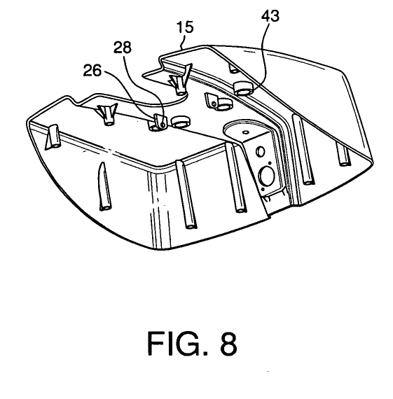

The securing member 24 has two mounting portions 26 comprising a set of tabs formed on the inside of the power supply 12, as shown in FIG. 8. The tabs extend downward from the top section 15 and into the interior of the assembly 12. An opening 28 is formed in each mounting portion 26 through which the ends of the member 24 are inserted. This configuration allows the securing member 24 to rotate about the openings in each mounting portion, while at the same time fixing the securing member 24 in place with respect to other directions of movement.

At least one resilient member 27, e.g., a spring, resides on the securing member 24, as shown in FIGS. 2, 3 and 7. The resilient member 27 urges the securing member 24 towards the seat support 16. The resilient member 27 is flexible to the extent that it deflects to allow the securing member 24 to rotate about the mounting 26 when a force is applied from the latch assembly.

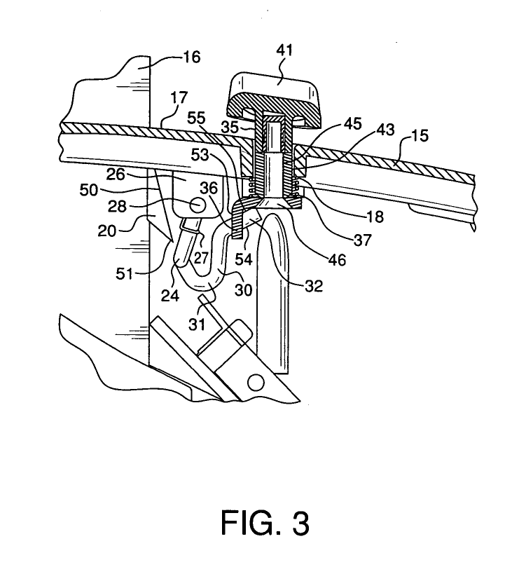

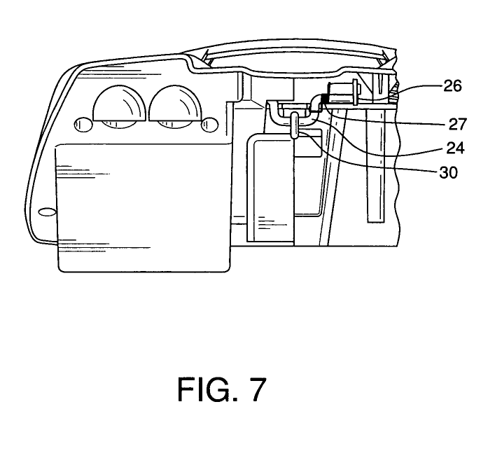

A joining member 30 is coupled to the securing member 24, as shown in FIGS. 1-4, 7, 9 and 10. The joining member 30 is coupled to the securing member 24 approximately in the center of the securing member 24 with respect to the securing member mounting portions 26, as shown in FIG. 7. The joining member 30 is preferably coupled to the securing member 24 using a welding process; however, it is understood that various other methods could be employed to couple the joining member 30 to the securing member 24, such a screw, pin, bracket, etc. As illustrated, the joining member 30 is formed in a modified “J” shape. Referring again to FIGS. 2 and 3, the joining member 30 comprises a curved end 31 and a straight end 32. The curved end 31 is fixed to the securing member 24, while the straight end 32 is coupled to the tab portion 36 of the handle assembly 40.

Referring to FIG. 4, the assembly 40 comprises a handle portion 41, connecting members 35a, 35b, handle resilient members 37a, 37b, a connector plate 34 and a tab 36. The handle portion 41 is formed from a thermoplastic material; however, alternate materials such as metal may also be used. The handle portion 41 partially resides on the exterior of the power supply assembly 12. The handle portion 41 is formed with a curved configuration to allow a user to insert his or her hand between the handle portion and the upper surface 17 of the top section 15 of the power supply assembly 12.

The handle portion 41 is attached to the connecting members 35a, 35b, which in turn connect to the portion of the latch assembly 14 that resides in the interior of the assembly 12. The connecting members 35a, 35b are coupled with the connector plate 34. As shown in FIGS. 2 and 3, the connecting members 35 pass through the opening 43 in top section 15. In an exemplary implementation, two connector portions are used to join the handle portion 41 to the connector plate 34; however, any number of connecting members could be utilized.

A cross-sectional view of a connecting member is shown in FIGS. 2 and 3. In an exemplary implementation, the bottom of the connecting member 35 contains a cavity 45 for receiving a screw 46. The screw 46 is used to couple the connector plate 34 to the connecting members 35. The connector plate 34 is relatively larger in size than the opening 43, and thus prevents the handle assembly 40 from being removed from the top 15 of the assembly 12.

The resilient members 37a, 37b are located between the connector plate 34 and the bottom surface 18 of the top section 15 at the opening 43. The resilient members 37a, 37b comprise springs surrounding the connecting members 35a, 35b. The resilient members 37a, 37b urge the handle portion 41 downward against the top surface 17 of top section 15 (the “down” position) when no lifting force is applied. When a force is applied to the handle portion 41 (i.e., a user pulls upward on the handle portion 41), the resilient members 37a, 37b are compressed, and the handle portion moves to the “up” position. When the lifting force is removed, the resilient members 37a, 37b expand and return the handle portion 41 to the retracted or down position.

Referring again to FIG. 4, the connector plate 34 connects the connecting members 35a, 35b on the inside of the assembly 12. The connector plate 34 is substantially flat except for a tab 36 which extends downward from the connector plate 34 on the side that faces the seat support 16. The joining member 30 is coupled to the tab 36 by inserting the straight end 32 into a tab opening 33. The tab opening 33 is slightly larger than the diameter of the straight end 32 and, as illustrated, is formed as a slot. This allows the joining member 30 to rotate or “rock” within the tab opening 33 in the vertical direction as the handle assembly 40 is moved. The tab opening 33 is preferably not large enough to allow the straight end 32 to become un-coupled from the tab 36. The slot configuration allows freedom of movement in the vertical direction, while limiting motion in the horizontal direction. The top and bottom surfaces of tab opening 33 may also be angled with respect to the front surface 53 of the tab 36 such that the top side 54 and bottom side 55 of the straight end 32 of the joining member 30 are in contact, or “flush,” with the interior surfaces of the opening when the handle assembly is in the “up” position, as more fully described below.

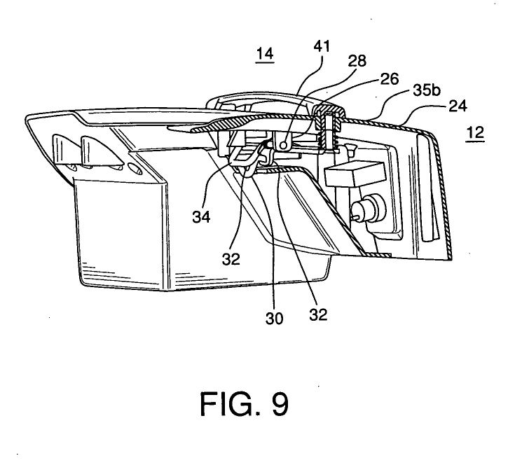

Following the structural recitation of the latch assembly elements set forth above, a functional explanation of the workings of the latch assembly 14 is described herein with reference to FIGS. 2, 3, 9 and 10. Referring to FIGS. 2 and 9, the latch assembly 14 is illustrated in a mated configuration or down position. The securing member 24 is coupled to the fixed member 20, which mates the assembly 12 to the vehicle 10. The securing member 24 is extended toward the seat support 16, or in the “forward” position.” The securing member 24 is held in the forward position as a result of the force applied by the resilient member 27. This holding action operates in conjunction with the downward forces exerted by the handle resilient members 37a, 37b on the connector plate 34, which in turn presses down on the straight end 32 of the joining member 30.

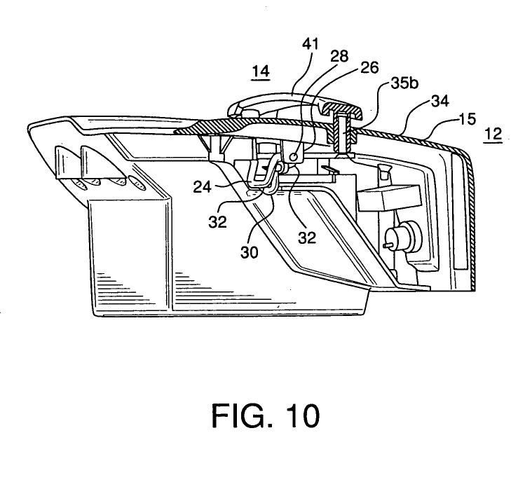

When it is desired to remove the assembly 12 from the vehicle 10, the latch assembly 14 must be moved into the unmated configuration. This is accomplished simply by pulling upward on the handle portion 41. When an upward force is applied to the handle 41, the latch assembly moves to the up position as shown in FIGS. 3 and 10. The force applied to the handle 41 is transferred via the connecting members 35a, 35b to the connector plate 34. Movement of the connector plate 34 upward toward the top portion 15 of the assembly 12 compresses the handle resilient members 37a, 37b.

When the connector plate 34 moves upward, an upward force is applied to the straight end 32 of the joining member 30. Because the opening 33 in the tab 36 of the connector plate 34 is formed in a slot configuration, the joining member 30 rocks or rotates in response. The straight end 32 of the joining member 30 raises upward, causing the curved end 32 of the joining member 30 to rotate away from the fixed member 20. This, in turn, exerts a force upon the securing member 24 causing the securing member 24 to rotate about its mounting points (the openings 28 in the securing mounting portions 26). When the securing member 24 rotates to the position illustrated in FIGS. 3 and 10, it becomes unmated with the fixed member 20, thus releasing the assembly 12 and allowing it to be removed from the vehicle 10.

When it is desired to re-mount the power supply assembly 12 on the vehicle 10, the assembly 12 can simply be placed back in position on the vehicle 10 and the latch assembly 14 will automatically secure it in place. Referring to FIGS. 2 and 3, the front surface 50 of the fixed member 20 is formed in an angled configuration. When the assembly 12 is placed on the vehicle 10, the front surface 50 of the fixed member 20 presses against the securing member 24. This causes the securing member 24 to rotate about its mounting points. Once the securing member 24 clears the tip 51 of the fixed member 20, the resilient member 27 urges it forward to lock the PSA 12 in place. In this manner, the assembly 12 simply snapped into the mated configuration when it is placed on the vehicle 10.

The present invention allows for simple, quick and easy removal of the power supply assembly 12 from the vehicle 10, along with a simple, quick and easy re-mounting of the assembly 12 onto the vehicle 10. Additionally, the configuration as shown allows for removal and re-mounting to be performed by the user using only a single hand and requires no other user efforts, which can be very advantageous as often a user may only have a single hand available (e.g., if the user also desires to carry other items simultaneously). As a result of facilitating easy removal and re-mounting of the assembly 12, the present invention makes it easier to dis-assemble the vehicle 10 to load into vehicles for transportation. The present invention may also make it easier to re-charge the power supply by making it easy to bring only the assembly 12 to the power source for re-charging. Thus, the vehicle 10 can remain in the trunk of a car while the assembly 12 is brought into the house for recharging.

A variety of modifications to the embodiments described will be apparent to those skilled in the art from the disclosure provided herein. Thus, the present invention may be embodied in other specific forms without departing from the spirit or essential attributes thereof and, accordingly, reference should be made to the appended claims, rather than to the foregoing specification, as indicating the scope of the invention.

1. A latch assembly for securing and releasing a power supply assembly to a vehicle comprising:
a securing member pivotably coupled to the power supply assembly;
a joining member having a first end and a second end, the first end coupled to the securing member; and
a handle for lifting and carrying the power supply assembly, the handle operatively coupled to the second end of the joining member;
wherein a force applied to the handle causes the joining member to rotate the securing member and release the power supply assembly from the vehicle.

2. The latch assembly as set forth in claim 1, wherein the securing member is U-shaped

3. The latch assembly as set forth in claim 1, wherein the handle further comprises:
a handle portion slidably mounted to the power supply assembly;
a connecting member coupled to said handle portion;
a connecting plate coupled to said connecting member; and
a resilient member, the resilient member residing between the connecting plate and the power supply assembly supplying a return force upon slideable movement of the handle portion.

4. The latch assembly as set forth in claim 3, wherein the joining member is coupled to the connecting plate via a tab portion containing an opening into which the joining member projects.

5. The latch assembly as set forth in claim 1, wherein the securing member is adopted to engage a fixed member on the vehicle for securing the power supply assembly to the vehicle.

6. The latch assembly as set forth in claim 6, further comprising a resilient member coupled to the securing member, wherein the resilient member urges the securing member towards the fixed member on the vehicle upon engagement of the power supply assembly with the vehicle.

7. The latch assembly as set forth in claim 1, wherein the joining structure has a curved end and a straight end.

8. The latch assembly as set forth in claim 1, wherein the joining structure is coupled to said handle assembly via an opening in a connecting tab having a front surface.

9. A power driven vehicle comprising:
a frame;
a plurality of wheels supported on the frame,
a seat for the user of the vehicle to sit on,
a seat support for supporting the seat on the frame,
a drive motor for propelling the vehicle,
a power supply assembly removably affixed to the frame and retaining a portable battery supply for operating the drive motor, the power supply assembly comprising
a moveable handle for lifting the assembly,
an enclosure for retaining the battery supply, and
a joining member operatively coupled to the handle, and
a fixed member on the frame, the joining member operatively coupling the power supply assembly to the frame and releasing the coupling upon activation by the handle.

10. A power driven vehicle as claimed in claim 9, further comprising a tiller supported on the frame, the tiller operatively coupled to at least one of the wheels for steering the vehicle.

11. A power driven vehicle as claimed in claim 9 wherein the power supply assembly further comprises resilient means for directing the joining member normally into an engagement position with the fixed member.

12. A power driven vehicle as claimed in claim 9 wherein the fixed member is secured to the seat post.

13. A power driven vehicle as claimed in claim 12 wherein the power supply assembly wraps around the seat post and electrically connects to the drive motor upon the assembly being affixed to the frame.

14. A power driven vehicle as claimed in claim 9 wherein the power supply assembly further comprises:
a connecting member, and
a connecting plate coupled to the handle and moveable therewith,
the connecting member pivotably retained on the connecting plate and coupled to the joining member,
a lifting movement of the handle causing a corresponding movement of the plate, a pivoting of the connecting member along with the plate, and a releasing motion of the joining member.

15. A power driven vehicle as claimed in claim 14, wherein the power supply assembly further comprises a resilient member acting between the plate and the enclosure to normally position the handle in the down position and, in turn, position the joining member in an engagement position with the fixed member.
